(19) United States
(12) Patent Application Publication
(10) Pub. No.: US 2014/0278864 A1
(43) Pub. Date: Sep. 18, 2014

(54) SYSTEMS, DEVICES, ARTICLES AND METHODS FOR TRACKING AND/OR INCENTIVIZING USER REFERRAL ACTIONS

(71) Applicant: Inside, Inc., Seattle, WA (US)

(72) Inventors: Brewster David Miles Stanislaw, Seattle, WA (US); Alan Roy Balasundaram, Renton, WA (US); Joseph Henry Kotkins, Seattle, WA (US)

(73) Assignee: Inside, Inc., Seattle, WA (US)

(21) Appl. No.: 14/184,493

(22) Filed: Feb. 19, 2014

Related U.S. Application Data
(60) Provisional application No. 61/799,245, filed on Mar. 15, 2013.

(51) Int. Cl. G06Q 30/02

(52) U.S. Cl. CPC G06Q 30/0246; G06Q 30/0214
USPC 705/14.16; 705/14.45

(57) ABSTRACT

Tracking, and possibly rewarding or incentivizing those who drive traffic includes causing sharing actions via social networking or media platforms to register such actions with a tracking server. Sharing may be via sharing widgets, posting on Web pages, and/or copying and pasting URLs. The effectiveness of the tracking may be tracked, including over generations. Incentives may be based on effectiveness of sharing actions, for example number of clicks, or social and actual revenue generated. Incentives may include access through a pay wall Website or free or discounted access to content, products, or services.

### BACKGROUND

1. Technical Field

This disclosure generally relates to tracking of user referral actions in networked systems, for instance World Wide Web (i.e., Web) based systems.

2. Description of the Related Art

Providers of Web pages derive financial benefit from users' referral actions, such as posting a Web address to a social networking site. However, it may be difficult to track user referral actions that originated from a provider's Web server. Thus, a solution is needed to understand and drive content sharing.

### BRIEF SUMMARY

A method in a Web server including at least one processor and at least one memory communicatively coupled to the at least one processor may be summarized as including receiving, by the at least one processor of the Web server, a Web page request for a Web page from a client; generating, by the at least one processor of the Web server, a Web page request identifier based on the received Web page request to uniquely identify the Web page request from other requests received by the Web server for the Web page and from requests for other Web pages; including, by the at least one processor of the Web server, the Web page request identifier in a metadata tag of the requested Web page; including, by the at least one processor of the Web server, a client side executable script with the Web page, the client side executable script which, when executed by a client side processor, causes the client to transmit a digital package including at least the Web page request identifier and a user identifier logically associable with the client; and transmitting, by the at least one processor of the Web server, the Web page including the Web page request identifier and including the client side executable script to the client in response to the request from the client.

The inclusion of the Web page request identifier in the metadata tag of the requested Web page may cause, subsequent to the transmission of the digital package, a data sharing server to communicate the Web page request identifier to a tracking server remote from the data sharing server should the client transmit a request to the data sharing server regarding dissemination of information associated with the requested Web page to one or more users. The client side executable script, when executed, may further cause the client to modify data indicative of a Web address of the Web page to include in the Web address of the Web page a user identifier associated with the client. The Web address of the Web page may be a uniform resource locator (URL). The Web page request identifier may include a reference to a tracking server.

A non-transitory computer-readable storage medium may be summarized as including having computer executable instructions stored thereon that, when executed by at least one processor, cause the at least one processor to: read or generate a particular user identifier associated with a user who requested a Web page; read a Web page request identifier in a metadata tag of the requested Web page, the Web page request identifier having one or more attributes which uniquely identify a request for the Web page from other requests received by a Web server for the Web page and from requests for other Web pages; determine whether data indicative of a Web address of the requested Web page includes an indication of a user identifier; if it is determined that the data indicative of the Web address of the requested Web page includes the indication of a user identifier, then transmits to a tracking server a digital package including at least the Web page request identifier, the indication of the user identifier that is included in the data indicative of the Web address of the requested Web page, and the particular user identifier associated with the user who requested the Web page.

The non-transitory computer-readable storage medium, if it is determined that the data indicative of the Web address of the requested Web page does not include the indication of a user identifier, may then modify the data indicative of the Web address of the requested Web page to include in the Web address of the requested Web page an indication of the particular user identifier associated with the user who requested the Web page. The indication of the particular user identifier may be a hash of the particular user identifier. The indication of the particular user identifier may be a query string of the particular user identifier. The particular user identifier associated with the user who requested the Web page may be an identifier of a client that generated the Web page request. The particular user identifier may be compared with the indication of the user identifier.

A method in a tracking server including at least one processor and at least one memory communicatively coupled to the at least one processor may be summarized as including receiving from a client, by the at least one processor of the tracking server, a digital package including at least a Web page request identifier of a Web page request for a Web page made to a Web server from the client and a user identifier logically associable with the client, the Web page request identifier uniquely identifying the Web page request from other requests received by the Web server for the Web page and from requests for other Web pages; storing, by the at least one processor of the tracking server, the Web page request identifier and the user identifier; receiving, by the at least one processor of the tracking server, a request via a data sharing server for data associated with an identifier included in the received data request; in response to receiving the request via the data sharing server, comparing, by the at least one processor of the tracking server, the stored Web page request identifier to the identifier included in the data request received via the data sharing server; and logically associating in a database stored on the at least one memory, by the at least one processor of the tracking server, a request from the client to the data sharing server regarding dissemination of information associated with the requested Web page with the data request received via the data sharing server, based at least in part on an outcome of the comparison.

The method may further include, in response to the data request received via the data sharing server, transmitting, by the at least one processor of the tracking server, the requested data to the data sharing server. The Web page request identifier may be indicative of an image stored by the tracking server. The method may further include associating in the database, by the at least one processor of the tracking server, the user identifier with the Web page request.

A method in a data sharing attribution system including at least one processor and at least one memory communicatively coupled to the at least one processor may be summarized as including receiving, by the at least one processor of the data sharing attribution system, data indicative of a first client associated with a first user; associating, by the at least one processor of the data sharing attribution system, a request to a data sharing server originating from the first client regarding dissemination of information associated with a Web page with subsequent Web page requests of a plurality of additional clients associated with a plurality of additional users based on modified Web page addresses associated with the Web page and tracking the request to the data sharing server via content requests resulting from the request to the data sharing server, the modified Web addresses including data indicative of which of the plurality of additional clients the subsequent requests were from; attributing, by the at least one processor of the data sharing attribution system, the subsequent Web page requests to the first user based on the received data indicative of the first client associated with the first user, and based on the association of the subsequent Web page requests with the request to the data sharing server originating from the first client; and determining a value of the communication originating from the first client based on the attribution.

A method in a server including at least one processor and at least one memory communicatively coupled to the at least one processor may be summarized as including determining, by the at least one processor of the server, an incentive for a first user based on tracking Web page visits of a plurality of users to a Web page which were a result of a particular request to a data sharing server originating from a client associated with the first user, the request regarding dissemination of information associated with the Web page; and sending, by the at least one processor of the server, the incentive to the first user. The incentive may be an offer. The incentive may be a prompt. The incentive may be access to content through a pay wall Website.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is an environmental diagram of an arrangement of networked components, according to one illustrated embodiment.

FIG. 2 is a schematic diagram of an arrangement of networked components, showing a data flow between the various components, according to one illustrated embodiment.

FIG. 3 is a schematic diagram of an arrangement of networked components, showing a data flow between a data sharing server computer and a Web content server computer, according to one illustrated embodiment.

FIG. 4 is a schematic diagram of an arrangement of networked components, showing a data flow between a tracking server computer and the data sharing server computer, according to one illustrated embodiment.

FIG. 5 is a schematic diagram of an example computer system which may constitute one or more of the components of FIG. 1, according to one illustrated embodiment.

FIG. 6 is a flow diagram of a method of operation in a Web content server computer, according to one illustrated embodiment.

FIG. 7 is a flow diagram of a method of operation in a Web content server computer, according to one illustrated embodiment, the method executable in addition to the method of FIG. 6.

FIG. 8 is a flow diagram of a method of operation in a client device, according to one illustrated embodiment.

FIGS. 9 and 10 together are a flow diagram of a method of operation in a client device, according to one illustrated embodiment.

FIG. 11 is a flow diagram of a method of operation in a tracking server, according to one illustrated embodiment.

FIG. 12 is a flow diagram of a method of operation in a tracking server, according to one illustrated embodiment, the method executable in addition to or as part of the method of FIG. 11.

FIG. 13 is a flow diagram of a method of operation in a tracking server, according to one illustrated embodiment, the method executable in addition to the method of FIG. 11.

FIG. 14 is a flow diagram of a method of operation in a data sharing attribution system, according to one illustrated embodiment.

FIG. 15 is a flow diagram of a method of operation in an incentive allocation server computer, according to one illustrated embodiment.

FIG. 16 is a screen shot showing a user interface that may be presented via an incentive allocation server computer, according to one illustrated embodiment.

FIG. 17 is a screen shot showing a user interface that may be presented via an incentive allocation server computer, according to one illustrated embodiment.

FIG. 18 is a screen shot showing a user interface that may be presented via an incentive allocation server computer, according to one illustrated embodiment.

FIG. 19 is a screen shot showing a user interface that may be presented via an incentive allocation server computer, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

FIG. 1 shows a networked environment 100, in which systems, devices articles and methods for tracking of user referral actions and incentivizing such may be performed or implemented, according to one illustrated embodiment. The networked environment 100 includes an arrangement of components, with various data flows therebetween.

The networked environment 100 may include one or more client devices 126, one or more Web content server computers 120, which may each have one or more plug-ins 122, one or more tracking server computers 124, and one or more data sharing server computers 128. The networked environment 100 may optionally include one or more data attribution systems 129 and/or one or more incentive allocation server computers 131. The client device(s) 126, Web content server computer(s) 120, tracking server computer(s) 124, data sharing server computer(s) 128, data attribution systems 129 and/or incentive allocation server computer(s) 131 may communicate with each other via the Internet 110, or any other suitable computer/telecommunications network that enables communication between the various devices shown in FIG. 1.

Typically, a client device 126 will transmit requests to a Web content server computer (also called Web server computer), requesting information. The Web content server computer responds to the request by providing information, typically in the form of Web pages, which are commonly encoded in a markup language file (e.g., HTML, XML). The provided information may include data, metadata (e.g., cookies) and/or executable code or scripts (e.g., JavaScript scripts).

While various embodiments are described in terms of the networked environment illustrated in FIG. 1, those skilled in the art will appreciate that embodiments may be implemented in a variety of other environments or forms, including various other combinations of computer systems or similar processor-based devices communicatively coupled in various ways. For instance, wired and wireless enterprise-wide computer networks, intranets, extranets, and/or the Internet may be included in or comprise a part of a networked environment. Embodiments may include various types of communication networks including other telecommunications networks, cellular networks, paging networks, and other mobile networks. There may be any variety of computers, switching devices, routers, bridges, firewalls, edge devices, multiplexers, phone lines, cables, telecommunications equipment and other devices within the Internet 110 or a suitable computer/telecommunications network. There are a variety of systems, components, network configurations that may also support the networked environment 100. Any such infrastructures may be used in conjunction with, be connected to, or comprise part of the networked environment 100.

Although not required, the embodiments will be described in the general context of computer-executable instructions, such as program application modules, objects, or macros stored on computer- or processor-readable storage media and executed by a computer or processor. Those skilled in the relevant art will appreciate that the illustrated embodiments as well as other embodiments can be practiced with other system configurations and/or other computing system configurations, including hand-held devices, multiprocessor systems, microprocessor-based or programmable consumer electronics, personal computers (PCs), network PCs, mini computers, mainframe computers, and the like. The embodiments can be practiced in distributed computing environments where tasks or modules are performed by remote processing devices, which are linked through a communications network such as Internet 110. In a distributed computing environment, program modules may be located in both local and remote memory storage devices.

Although the physical networked environment 100 may have connected devices such as computers, the physical environment may alternatively have or be described as comprising various digital or processor-based devices such as smart phones, personal digital assistants (PDAs), televisions, MP3 players, etc.

FIG. 2 shows a portion of the networked environment 100, according to one illustrated embodiment. In particular, FIG. 2 shows operation of one or more Web content server computers 120 (only one shown) during a first period to provide Web pages to one or more client devices 126 (only one shown). One or more data sharing server computers 128 (only one shown) operate to allow data sharing between client devices 126, for example via various social networking techniques. Data sharing techniques may, for instance, include use of a social media control, for example a share widget, such as selection of a user selectable social media or social networking icon (e.g., “share” and “like” for FACEBOOK®, “tweet” and “follow” for TWITTER®, “pin” for PINTEREST®, other icons for YOUTUBE®, DIGG®, LINKEDIN®) displayed on a Web page. Data sharing techniques may include posting, linking or otherwise sharing, for instance posting on a wall in the user's FACEBOOK® account. Data sharing techniques may include copying and pasting a URL. The approaches discussed herein advantageously may work with all three of these distinct data sharing techniques.

The Web content server computer 120 may take the form of a dedicated Web server computer system to serve content, or may take the form of a service or application executing on a non-dedicated or general computer system (e.g., personal computer system) that serves content (e.g., commercial Web pages). The Web content server computer 120 may be operated by any entity that desires to have a presence on the World Wide Web or Internet, for example business, individuals, governmental organizations and/or nongovernmental organizations. The Web content server computer may be operated by a Web hosting entity for another entity that desires a presence on the World Wide Web or Internet.

The client devices 126 may take the form of any processor-based device that is capable of communications via a network, for instance the World Wide Web portion of the Internet. Some example client devices 126 include desktop computers, laptop computers, netbook computers, tablet computers, smart phones, or personal digital assistants. The client devices 126 are operated by any entity that desires to share information via the network. For example, the client devices 126 may be operated by an individual who maintains a blog, tweets, posts, or otherwise recommends or comments on various goods, and/or services or who has opinions on various matters (e.g., politics, religion, the price of tea in China).

The data sharing server computer 128 may take the form of a dedicated Web content server computer system that provides social networking functionality to a plurality of end users or client devices 126. Examples of a data sharing server 128 include server computer systems operated for or by FACEBOOK®, TWITTER®, LINKEDIN®, PINTEREST®, MYSPACE®, GOOGLE+®, TAGGED®, DIGG®, YOUTUBE®, LIVE JOURNAL®, ORKUT®, TUMBLR®, SINA WEIBO®, to name a few. The data sharing server computer 128 may take the form of any Web server or service that allows users to link or share with others the material they found on other Websites. For instance, a user of a client device 126 may find an interesting article on a Web page hosted by the Web content server computer 120. The user decides to share that article with other users. Thus, the user may use a social media control, for example a share widget, (e.g., select a corresponding social media or social networking icon) that appears on the Web page with the article. The social media control may be native to the social media, such as native code provided by FACEBOOK®, TWITTER®, etc., or may be a product by a third party, such as ADDTHIS®, SHARETHIS®, etc. Alternatively, the user may post or link to the Web page in a social networking or social media account. Alternatively, the user may cut and paste a URL of the Web page.

One of the problems addressed herein is the ability to track, and possibly reward or incentivize, those who drive traffic. In the above example, a user operating a client device may be providing recommendations or referrals which may generate traffic. For example, the user operating the client device 136 may generate traffic to the Web content server computer 120 by recommendations or referrals via one or more social networking sites (e.g., data sharing server computer 128).

Some users may be more effective at generating traffic, either through sheer volume of recommendations or referrals, or effectiveness of those recommendations or referrals (e.g., through the following that the user has and/or persuasiveness of the user). Monitoring and/or crediting this ability has become increasingly important.

A tracking server computer 124 (FIG. 1) may supply the Web content server 120 with a plug-in 122. A plug-in 122 is, for example, a set of software components that add specific abilities to a host application or a larger software application. A plug-in may also be known as an add-on, applet, snap-in, or the like. A host application may provide services which a plug-in may use. The plug-in facilitates the tracking server computer 124 in tracking the performance of various users or client devices 126 in generating or driving traffic to the Web content server computer(s) 120. The operator of the Web content server computer 120 or entity for who the Website is hosted may be motivated to employ the plug-in 122 in order to learn who drives traffic to their Website, and possibly reward those users who are most effective at driving traffic.

In operation, the Web content server computer 120 may receive a Web page request 130 from a client device 126. The Web page request 130 may be in the form of a URL or a character string that constitutes a reference to a resource. Upon receipt of the Web page request 130, the plug-in 122 of the Web content server computer 120 generates a unique identifier that represents the request for the Web page (i.e., Web page request) 130. A Web page request identifier may be a unique value that may be pseudo-randomly generated, such that each Web page request from the same user for the same Web page is associated with a unique identifier different from the unique identifier previously generated for a request by that same user for that same Web page. Thus, each Web page request identifier may uniquely identify each Web page request. Additionally, the Web page request identifier may be generated so that, later, a Web page request identifier may identify or be associated with an image or other resource.

The plug-in 122 may advantageously incorporate or inject the Web page request identifier in a metadata tag of the requested Web page. The inclusion or injection may be performed by including the Web page request identifier with an image metadata tag. The inclusion or injection may include a URL of a server, such as a tracking server computer 124. Thus, the combination of a URL of a tracking server computer 124 with a Web page request identifier, which may be injected in an image metadata tag, is a reference to a resource, such as an image, on the tracking server computer 124.

The plug-in 122 may inject a client side executable script 127 with the Web page. The client side executable script 127 may be written in a client side scripting language, such as JavaScript, an interpreted computer programming language, or the like. In some embodiments, a server side plug-in and a client side executable script are installed on the Web page. A client side executable script 127 may be executed by a Web browser, or the like, being executed by the client device 126.

In response to the Web page request 130, the Web content server computer 120 may transmit a Web page response 132. The transmission may, for example, be consistent with Hypertext Transfer Protocol (HTTP). The Web page response 132 may be a Web page, or the like. The Web page response 132 sent to the client device 126 by the Web content server 120 may include a Web page request identifier, a reference to a tracking server computer 124 that has a resource, such as an image, and a client side executable script 127. The reference to the tracking server computer 124 and the Web page request identifier may be combined in an image metadata tag, or the like, of the Web page.

As noted above, a Web page response 132 may include a Web page request identifier that is unique to the Web page request. In other words, if a client device 126 transmits a URL, a first Web page request identifier may be returned. If the same client device 126 transmits the same URL a second time, a second Web page request identifier would be returned from the Web content server computer 120 that is different from the first Web page request. In other words, a Web page request identifier has one or more attributes which uniquely identify a request for a Web page from other requests received by a Web content server for the Web page and from requests for other Web pages. A Web page request identifier may be included in a metadata tag of a Web page.

A Web page response 132 may also include a reference to a tracking server computer 124. This reference may also be included in a metadata tag of a Web page. Such a metadata tag may be the same as the one holding a Web page request identifier, or may be different. The metadata tag may advantageously be an image metadata tag.

A Web page response 132 may include a client side executable script 127. The client side executable script 127 can read a user identifier from the client device 126, or can generate a user identifier if one cannot be read. A user identifier may be stored in a cookie, or an equivalent, of the client device 126.

A client side executable script 127 may cause an indication of a user identifier to be included in data indicative of a Web address. Such data may be a URL, or the like. An indication of a user identifier may be the user identifier, a hash of the user identifier, a query string of the user identifier, or the like. If it is determined that an indication of a user identifier is not included in data indicative of a Web address, then the data indicative of a Web address may be modified to include in the Web address an indication of the particular user identifier associated with the user who requested the Web page. A user identifier may alternatively be associated with a client device 126. If it is determined that an indication of a user identifier is included in data indicative of a Web address, then the data indicative of a Web address is not modified.

The indication of a user identifier included in data indicative of a Web address may be compared to a user identifier particular to a client device 126. If a comparison is indicated, then it can be determined that the Web address was not shared. Alternatively, if the comparison is not indicated, then it can be determined that the Web address was shared. In other words, a first user may first request a Web page, causing a client side executable script 127 to modify a Web address with an indication of the first user identifier. If the first user shares the Web page with a second user, the second user identifier of the second user's client will be different from the first user identifier. In this example, the indication of the first user identifier included in the modified data indicative of a Web address would not compare with the second user identifier. Determining such a comparison can be an indication of whether or not a Web address was shared. This determination may be made at a client device 126 and/or a tracking server 124.

A client side executable script 127 may cause the client device 126 to transmit, via the Internet 110, a digital package 138 to a tracking server 124. The digital package 138 may include a Web page request identifier, an indication of a user identifier from the data indicative of the Web address, and/or a user identifier logically associable with the client device 126. The digital package facilitates the tracking server computer 124 in tracking recommendations, referrals, sharings, postings, linkings, “liking,” “tweeting”, “pinning” “hash tagging” (collectively, disseminations) of various Web pages by various users via client devices 126.

The client device 126 may transmit a dissemination request 140 to a data sharing server computer 128. A dissemination request 140 may be the sharing of content and/or content by reference such as a Web address. Such may take any of a large variety of forms, many of which have been increasingly popular with the growth of social networking. For example, use of a social media control, for example a share widget, associated with FACEBOOK®, LINKED IN®, TWITTER®, PINTEREST®, YOUTUBE®, etc.

A dissemination request 140 may include dissemination of a Web page or URL, or the like, which includes a metadata tag. The metadata tag may include a Web page request identifier and/or a reference to a tracking server computer 124, as discussed previously. The metadata tag may be included in an iframe injected into a Web page. An iframe is also known as an invisible frame, and an iframe may be injected, for example, into the HTML of a Web page. The iframe may be injected into a Web page by a client side executable script 127 executed on a client device 126 or a plug-in 122 of a Web content server computer 120.

The client side executable script 127 may cause the dissemination request 140 to include an indication of a user identifier, for example included in data indicative of the Web address, as discussed previously.

FIG. 3 shows a portion of the networked environment 100, according to one illustrated embodiment. In particular, FIG. 3 shows operation of a data sharing server computer 128 during a second period, in response to a dissemination request 140 by a client device 126. The second period may, at least partially, overlap with the first period (FIG. 2).

A data sharing server computer 128 may host social networking or social media activities and/or social bookmarking activities for an online service, platform, or site, such as FACEBOOK®, TWITTER®, GOOGLE+®, LINKEDIN®, and the like. A user may share content and/or content by reference via the data sharing server computer 128, for example via the use of a share widget, posting, or cut and paste of an URL. In response, the data sharing server computer 128 may request content or additional content from a Web content server computer 120, as is done for example, via FACEBOOK's® Open Graph® methodologies.

In particular, in response to the dissemination request 140 by a client device 126, the data sharing server computer 128 may parse the dissemination request 140 and transmit a content request 134 to Web content server computer 120 to retrieve the content of the Web page which was identified by the user operating the client device 126. For example, the user operating the client device 126 may have pointed to a Web page hosted by Web content server 120, for example via some social network sharing widget. In response, the data sharing server computer 128 will typically retrieve and cache the content of the Web page, particularly if such has not been recently cached.

If the data sharing server computer 128 sent a request for content to the Web content server computer 120, the Web content server computer 120 may transmit a content response 136 with the requested content to the data sharing server 128. As noted above, the data sharing server computer 128 will typically cache requested content in anticipation of further requests. Also as alluded to above, the data sharing server computer 128 may omit requesting content where the content has recently been cached.

FIG. 4 shows a portion of the networked environment 100, according to one illustrated embodiment. In particular, FIG. 4 shows operation of a tracking server computer 124, and interaction between the data sharing server computer 128 and the tracking server computer 124 during a third period, to track dissemination of content by the user of the client device 126 via a data sharing server computer 128 such as a social networking Website. The third period may, at least partially, overlap with the first (FIG. 2) and/or second (FIG. 3) periods.

As previously explained, the tracking server computer 124 may receive a digital package 138. A digital package 138 may include a Web page request identifier, an indication of a user identifier from the data indicative of the Web address, and/or a user identifier logically associable with a client device 126. The tracking server computer 124 implements one or more databases or other logical data constructs to store the information contained in a digital package 138. The database(s) or other logical data constructs may be stored on one or more nontransitory computer- or process-readable media.

The tracking server computer 124 may logically associate a Web page request identifier of the digital package 138 with a user identifier logically associable with a client device 126, for example via the database(s) or other logical data constructs. This logical association enables the tracking server 124 to determine each Web page request 130 requested by a given user or client device 126. It is noted that client devices 126 are treated herein as proxies for users. Client devices 126 are typically more easily uniquely identifiable than a human user. However, it would be possible to track users directly, for example by requiring user names and/or passwords. Users may also be tracked by associating client devices with social networking profiles. This may facilitate tracking a user across multiple client devices 126 (e.g., personal computer, tablet device, smart phone).

The tracking server computer 124 may associate an indication of a user identifier from the data indicative of the Web address with a user identifier logically associable with a user or client device 126. This logical association, as discussed previously, enables the tracking server computer 124 to determine whether or not a Web page was shared between users.

Importantly, the inclusion of the reference to the tracking server in the dissemination request 140 (FIG. 2), causes the data sharing server computer 128 (e.g., social networking hosting server computer) to send a data request 142 to the tracking server computer 124. The data request 142 to the tracking server computer 124 may be in addition to, or in place of, a content request 134 (FIG. 3) sent to the Web content server computer 120 by the data sharing server computer 128 for the content on the Web page that is being disseminated. This allows the tracking server computer 124 to track each dissemination request 140 (FIG. 2) or dissemination event. Further, the inclusion of the Web page request identifier in the dissemination request 140 (FIG. 2) provides the tracking server computer 124 with the information needed to identify the client device 126 which shared the Web page (i.e., generated the dissemination request 140). Importantly, the inclusion Web page request identifier causes the data sharing server computer 128 to treat each dissemination request 140 as sharing of new content, even if such corresponds to a Web page that was previously shared. Thus, the data sharing server computer 128 will not find a recently cached version of the particular content (e.g., image metadata tag), causing the data sharing server computer 128 to send the data request 142 to the tracking server computer 124 each time a dissemination request 140 (FIG. 2) is received by the data sharing server computer 128.

The approach described above may advantageously force the data sharing server computer 128 to attempt to retrieve content from the tracking server computer 124 every time a dissemination request 140 (FIG. 2) occurs, even if most of the content had been recently cached by the data sharing server computer 128.

Thus, when a Web page request identifier is included in an image metadata tag of a Web page, and the metadata tag includes a reference to the tracking server computer 124, when the Web page is disseminated to a data sharing server 128, the data sharing server computer 128 will transmit a data request 142 requesting an image. When the tracking server computer 124 receives the data request 142 for an image, it receives the Web page request identifier.

The tracking server computer 124 may compare the Web page request identifier received in the data request 142 with a Web page request identifier received from a client device 126 in a data package 138. From the comparison, the tracking server computer 124 can determine whether a Web page associated with a Web page request 130 of a Web content server 120 was subsequently shared via a data sharing server 128. Additionally, when a digital package 138 includes a user identifier of a client device 126, and that user identifier is associated with a Web page request identifier as described previously, the tracking server computer 130 may also associate the dissemination request 140 with that user identifier through the Web page request identifier transmitted with the data request 142. In this way, the tracking server computer 124 can track user recommendation, referral or sharing actions.

In response to a dissemination request 140, the data sharing server computer 128 may transmit a data request 142 to a tracking server computer 124, and optionally transmit the content request 134 (FIG. 3) to the Web content server computer 120. For example, if a user shares a Web page to a data sharing server computer 128, such as FACEBOOK® under the Open Graph® methodologies, and the Web page has a first image tag with a reference to a first image at a Web content server computer 120, and the Web page has a second image tag with a reference to a second image at a tracking server computer 124, the data sharing server computer 128 will request the first image from the Web content server computer 120 (e.g., content request 134) assuming such was not recently cached. The data sharing server computer 128 will request the second image from the tracking server computer 124 (e.g., data request 142). The two images of a Web page are illustrated below in Table 1, in which 1234567 represents a unique Web page request identifier.

TABLE 1

Title: HelloWorld
Desc: My First Post
Img1: www.webserver.com/hello.gif
Img2: www.trackingserver.com/1234567

The data of the data response 144 may or may not be unique. Under an embodiment, the data of the data response 144 may be the same for two different data requests 142, where a first Web page request identifier is different from a second Web page request identifier. The data need not be unique because the tracking server computer 124 has received a unique Web page request identifier with the data request 142, and it is the unique Web page request identifier that is beneficial for the tracking server computer 124 to be able to track dissemination requests 140 related to Web page requests 130. Although the data may have different forms, in some embodiments, the data may be a non-unique image that is transmitted in a data response 144.

FIG. 5 shows an example computer system 200, according to one illustrated embodiment. The example computer system 200 may be employed as the Web content server computer 120, tracking server computer 124, client device 126, and/or data sharing server computer 128 of FIG. 1. The computer system 200 is suitable for implementing systems, devices and methods for tracking of user referral, recommendation, or sharing actions, according to one illustrated embodiment. The computer system 200 will at times be referred to in the singular herein, but this is not intended to limit the embodiments to a single device since in typical embodiments, there may be more than one computer system or device involved. Unless described otherwise, the construction and operation of the various blocks shown in FIG. 5 are of conventional design. As a result, such blocks need not be described in further detail herein, as they will be understood by those skilled in the relevant art.

The computer system 200 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (ROM) 218 and random access memory (RAM) 220. A basic input/output system (BIOS) 222, which can form part of the ROM 218, contains basic routines that help transfer information between elements within the computer system 200, such as during start-up.

The computer system 200 may also include a plurality of interfaces such as network interface 260, interface 250 supporting modem 262 or any other wireless/wired interfaces.

The computer system 200 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide non-volatile and non-transitory storage of computer readable instructions, data structures, program modules and other data for the computer system 200. Although the depicted computer system 200 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, digital video disks (DVD), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 212a.

Program modules can be stored in the system memory 214, such as an operating system 236, one or more application programs 238, other programs or modules 240 and program data 242. Application programs 238 may include instructions that cause the processor(s) 212 to automatically provide dynamic selection of data and telecommunication service providers before or during communications between various devices such as, for example, a mobile device and a landline telephone. Other program modules 240 may include instructions for handling security such as password or other access protection and communications encryption. The system memory 214 may also include communications programs, for example, a Web client or browser 244 for permitting the computer system 200 to access and exchange data with sources such as Web sites of the Internet, corporate intranets, extranets, or other networks and devices as described herein, as well as other server applications on server computing systems. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

While shown in FIG. 5 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the computer system 200 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (USB) can be used. A monitor 252 or other display device is coupled to the system bus 216 via a video interface 254, such as a video adapter. The computer system 200 can include other output devices, such as speakers, printers, etc.

The computer system 200 can operate in a networked environment using logical connections to one or more remote computers and/or devices as described above with reference to FIG. 1. For example, the computer system 200 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

It should be understood that the various techniques described herein may be implemented in connection with hardware, software and/or firmware or, where appropriate, with a combination of such. Thus, the methods and apparatuses of the disclosure, or certain aspects or portions thereof, may take the form of program code (i.e., instructions) embodied in tangible media, such as floppy diskettes, CD-ROMs, hard drives, flash drives, or any other machine-readable or processor-readable storage medium wherein, when the program code is loaded into and executed by a machine, such as a processor of a computer or mobile device, the machine becomes an apparatus for practicing various embodiments. In the case of program code execution on programmable computers or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system including the computer system 200 depicted in FIG. 5. However, the program(s) can be implemented in assembly or machine language, if desired. In any case, the language may be a compiled or interpreted language, and combined with hardware implementations.

FIG. 6 shows a method 300 of operation in a Web content server computer in order to receive a Web page request and transmit a Web page to a client device, according to one illustrated embodiment. For example, the Web content server computer 120, which may include at least one processor and at least one memory communicatively coupled to the at least one processor, may perform or control performance of the method 300 illustrated in FIG. 6.

The method 300 starts at 301. For example, the method 300 may start in response to turning ON or booting up of the Web content server computer, or in response to a calling routine.

At 302, a Web page request 130 (FIG. 2) for a Web page is received from a client device 126 (FIG. 2). In various embodiments, this request takes a variety of forms. In some embodiments, the request identifies content, such as an HTTP request that identifies a URL specifying content, such as by using a Web browser application executed on a client computer system or other device.

At 304, a Web page request identifier is generated. As described above, a Web page request identifier is a unique identifier for each Web page request. A Web page request identifier is based on a received Web page request that uniquely identifies the Web page request from other requests received by a Web content server for the Web page and from requests for other Web pages.

At 306, the Web page request identifier is included in a metadata tag of a Web page. In various embodiments, the metadata tag may be any tag capable of including a Web page request identifier. In some embodiments, the metadata tag is an image tag. In some embodiments, the Web page request identifier will include a reference to a tracking server that specifies content on the tracking server. In some embodiments the content on the tracking server may be an image.

At 308, a client side executable script 127 (FIG. 2) may be included with the Web page. In some embodiments, the client side executable script 127 causes a client device 126 to transmit a digital package 138 (FIG. 2) that includes the Web page request identifier and a user identifier of a client device. The user identifier may be logically associable with the client device.

At 310 the Web page may be transmitted to a client in response to the received request at 302. The Web page may include the Web page request identifier. The Web page may include the client side executable script 127 (FIG. 2).

The method 300 may terminate or end at 312. Alternatively, the method 300 may repeat, either continuously, periodically or aperiodically.

FIG. 7 shows a method 320 of operation in a data sharing server computer, according to one illustrated embodiment. The data sharing server computer may take the form of the data sharing server computer 128 previously illustrated and discussed.

The method 320 starts at 322. For example, the method 320 may start in response to turning ON or booting up of the data sharing server computer, or in response to a call from a calling routine.

At 324, the inclusion of a Web page request identifier in a metadata tag of a requested Web page, as at 308 described above, causes the data sharing server computer to communicate the Web page request identifier to a tracking server computer in response to a client transmitting a request to disseminate information associated with the requested Web page to the data sharing server computer 128.

The various techniques involved are discussed in detail above, for example in reference to FIG. 5.

The method 320 may terminate or end at 326. Alternatively, the method 320 may repeat, either continuously, periodically or aperiodically.

FIG. 8 shows a method 330 of operation of a client device, according to one illustrated embodiment. The client device may take the form of any of the client devices 126 previously illustrated or described.

The method 330 starts at 332. For example, the method 330 may start in response to receiving a Web page with an executable script from a Web content server computer.

At 334, a client side executable script may cause modification of data indicative of a Web address. In some embodiments the Web address of the Web page is a URL. In some embodiments, the client side executable script may cause a modification to the rendering of a Web page.

The method 330 may terminate or end at 336. Alternatively, the method 330 may repeat, either continuously, periodically or aperiodically, for example in response to receipt of additional Web pages.

FIGS. 9 and 10 show a method 340 of operation in a client device in order to transmit a digital package to a tracking server, according to one illustrated embodiment. The method 340 may be performed or executed, for example, following performance or execution of the method 330 (FIG. 9). The client device may take the form of any of the client devices 126 previously illustrated or described.

The method 340 starts at 342. For example, the method 340 may start in response to receiving a Web page from a Web content server computer.

At 344, a particular user identifier is either read or generated. In some embodiments, the particular user identifier may be associated with a user who requested a Web page. In some embodiments, the particular user identifier may be associated with a client or client device. The particular user identifier may be read from a storage medium, for example, a cookie associated with the Web page on the client device. In some embodiments, the particular user identifier associated with a user who, or client device which, requested a Web page may be an identifier of a client device that generated the Web page request.

At 346, a Web page request identifier may be read. In some embodiments, the Web page request identifier may be read from a metadata tag of the requested Web page. The Web page request identifier may have one or more attributes which uniquely identify a request for the Web page from other requests received by a Web content server for the Web page and from requests for other Web pages.

At 348, the client device determines whether an indication of a user identifier is included in data that is indicative of a Web address of the requested Web page. The indication of a user identifier may be different or the same from the particular user identifier that is read or generated at 344. In some embodiments, the indication of a user identifier may represent a user who originally requested a Web page. The particular user identifier may represent a user or client device to whom the requested Web page was shared by an original user or another intermediary user. In some embodiments, the indication of a user identifier may be a user identifier, a hash of a user identifier, a query string of a user identifier, or the like.

If the determination indicates an indication of a user identifier is included in data indicative of a Web address at 348, then the client device transmits a digital package to a tracking server computer at 350. In some embodiments, the digital package may include the Web page request identifier, the indication of the user identifier in the Web address, and the particular user identifier. In some embodiments, before the digital package is transmitted, the client device may determine whether the indication of the user identifier does not compare to the particular user identifier, and this determination may be transmitted with the digital package. Alternatively, in some embodiments, a tracking server may make this determination.

If the determination at 348 does not indicate that an indication of a user identifier is included in data indicative of a Web address, then the client device may modify data indicative of a Web address to include an indication of the particular user identifier at 352. In some embodiments, because data indicative of a Web address does not include an indication of a user identifier, the client device, or alternatively the Web content server computer may, determine whether the current user is an original or first user of a requested Web page. In some embodiments, by modifying data indicative of a Web address of the Web page to include an indication of the particular user identifier, should the Web page be shared with a second or other user, such can be determined in part because the second or other user's user identifier would not compare to the indication of the user identifier included in data indicative of a Web address.

The method 340 may terminate or end at 354. Alternatively, the method 340 may repeat, either continuously, periodically or aperiodically, for example in response to receipt of additional Web pages.

FIG. 11 shows a method 360 of operation in a tracking server computer in order to associate a request from a client device to a data sharing server computer with a data request received via the data sharing server computer, according to one illustrated embodiment. The tracking server computer may, for example, take the form of the tracking server 124 previously illustrated and described, which may include at least one processor and at least one memory communicatively coupled to the at least one processor to perform, execute or control the method 360.

The method 360 starts at 362. For example, the method 340 may start in response to a turning ON or booting up of the tracking server computer, or in response to receiving information, for instance a digital package from a client device and/or a data request from a data sharing server computer.

At 364, the tracking server computer receives a digital package from a client device. As previously explained, the digital package may include at least a Web page request identifier and a user identifier. In some embodiments, the user identifier may be logically associable with a client. In some embodiments, the Web page request identifier may be of a Web page request for a Web page sent to a Web content server computer from the client device. In some embodiments, the Web page request identifier uniquely identifies the Web page request from other requests received by the Web content server computer for the Web page and from requests for other Web pages. In some embodiments, the Web page request identifier is indicative of an image stored by the tracking server.

At 366, the tracking server computer stores the Web page request identifier and the user identifier. In some embodiments, the tracking server computer may store the Web page request identifier in logical association with the user identifier via one or more logical constructs or data structures.

At 368, the tracking server computer may receive a data request for data via a data sharing server computer. In some embodiments, the data request may be for data associated with an identifier included in the received data request. In some embodiments, the identifier may be a Web page request identifier. In some embodiments, the identifier includes a reference to the tracking server computer, for example a URL.

At 370, the tracking server computer compares the stored Web page request identifier to the identifier included in the data request received via the data sharing server computer. In some embodiments, the comparison may be in response to receiving the data request from the data sharing server.

At 372, the tracking server computer logically associates a request from the client device to the data sharing server computer regarding dissemination of Web page information with the data request received via the data sharing server computer. In some embodiments, the request received via the data sharing server computer is for data. In some embodiments, the logical association may be based at least in part on an outcome of the comparison at 370. In some embodiments, the Web page information may be content of a Web page, or a reference to content of a Web page, or the like.

The method 360 may terminate or end at 374. Alternatively, the method 360 may repeat, either continuously, periodically or aperiodically, for example in response to receipt of additional information from the client devices or data requests from the data sharing server computers.

FIG. 12 shows a method 380 of operation in a tracking server, according to one illustrated embodiment. The method 380 may be performed as part of, or in support of, the method 360 (FIG. 11).

The method 380 starts at 382. For example, the method 380 may start in response to a turning ON or booting up of the tracking server computer, or in response to receiving a data request from a data sharing server computer.

At 384, in response to the data request received via the data sharing server computer at 368, the tracking server computer may transmit the requested data to the data sharing server. In some embodiments, the requested data may be unique for each request for data. In some embodiments, the requested data may not be unique for each request for data. In some embodiments, the data is essentially a null set of data or is not visually discernible when displayed or otherwise rendered.

The method 380 may terminate or end at 384. Alternatively, the method 380 may repeat, either continuously, periodically or aperiodically, for example in response to receipt of additional information from the client devices or data requests from the data sharing server computers.

FIG. 13 shows a method 390 of operation in a tracking server, according to one illustrated embodiment.

The method 390 starts at 392. For example, the method 390 may start in response to a turning ON or booting up of the tracking server computer, or in response to receiving information, for instance a digital package from a client device.

At 394, the tracking server computer may logically associate the user identifier and the Web page request identifier received from the client in a digital package at 364. The tracking server computer may logically associate such in a database or other data construct or structure.

The method 390 may terminate or end at 394. Alternatively, the method 390 may repeat, either continuously, periodically or aperiodically, for example in response to receipt of additional information from the client devices.

FIG. 14 shows a method 500 of operation in a data attribution system in order to determine a value of communication, according to one illustrated embodiment. Monitoring and/or crediting recommendation, referral or sharing actions has become increasingly important in driving traffic.

The data attribution system 129 may include at least one processor and at least one memory communicatively coupled to the at least one processor, which performs, executes or controls the method 500. In some embodiments, the data attribution system 129 may be implemented by the tracking server 124 or the incentive allocation server computer 131.

The method 500 starts at 502. For example, the method 500 may start in response to a turning ON or booting up of the data attribution system computer, or in response to receiving information, for instance from the tracking server computer(s).

At 504, the data attribution system 129 receives data that is indicative of a first client device. In some embodiments the data indicative of a first client device may be associated with a first user. In some embodiments the data may be indicative of a first user.

At 506, the data attribution system 129 may logically associate a first client's dissemination request to a data sharing server computer regarding dissemination of Web page information with subsequent Web page requests of a plurality of additional users or client devices. In some embodiments, the first client's dissemination request to a data sharing server computer originates from the first client device. In some embodiments, the dissemination request is associated with a user or client device. In some embodiments, the data attribution system 129 logically associates subsequent Web page requests of a plurality of additional client devices with a plurality of additional users. In some embodiments, the logical association may be based on modified Web page addresses associated with the Web page. In some embodiments, the modified Web addresses may include data indicative of which of the plurality of additional clients the subsequent requests were from. In some embodiments, as described above, the dissemination request to the data sharing server computer may be tracked via content requests resulting from the request to the data sharing server.

At 508, the data attribution system 129 may attribute the subsequent Web page requests to the first client. To be clear, such is giving attribution to the first client for driving the subsequent Web page requests, rather than making the subsequent Web page requests themselves. In some embodiments, the data attribution system may attribute the subsequent Web page requests to the first user. In some embodiments, the attribution may be based on the received data indicative of the first client associated with the first user. In some embodiments, the attribution may be based on the association of the subsequent Web page requests with the request to the data sharing server originating from the first client device.

At 510, the data attribution system 129 determines a value of a communication from the first client. In some embodiments, the value may be based on the attribution. In some embodiments, the value may be relative to other communications originating from the first client. In some embodiments, the value may be relative to communications originating from other clients.

The data attribution system 129 may take into account a variety of factors when determining a value. For example, the data attribution system 129 may take into account an effectiveness of the first client at generating traffic. For example, the data attribution system 129 may assess the volume of recommendation, referral or sharing actions. Additionally or alternatively, the data attribution system 129 may take into account an assessed effectiveness of those recommendation, referral or sharing actions (e.g., the following that the user has and/or persuasiveness of the user). Additionally or alternatively, the data attribution system 129 may take into account a number or percentage of those of recommendation, referral or sharing actions that result in some defined action. For instance, data attribution system 129 may take into account a number or percentage of those of recommendation, referral or sharing actions that result in a viewing or linking to a Web page or an item for sale. Also for instance, the data attribution system 129 may take into account a number or percentage of those of recommendation, referral or sharing actions that result in a sale of a good or service. As a further example, the data attribution system 129 may take into account a number or percentage of those of recommendation, referral or sharing actions that result in a further recommendation, referral or sharing action. As a further example, the data attribution system 129 may take into account how much revenue a referral action generated, such as by advertisements from referral page views or transactional revenue via subscription and/or product sales.

The method 500 may terminate or end at 512. Alternatively, the method 500 may repeat, either continuously, periodically or aperiodically, for example in response to receipt of additional information from the tracking server computers.

FIG. 15 shows a method 600 of operation in an incentive allocation server computer 131 in order to determine an incentive or offer. In some embodiments, the incentive allocation server computer 131 may take the form of the tracking server 124 previously illustrated and discussed. Alternatively or additionally, the incentive allocation server computer may take the form of the data attribution system 129 illustrated and described previously. Alternatively or additionally, the incentive allocation server computer may take the form of the Web content server computer 120 illustrated and described previously.

The incentive allocation server computer 131 may include at least one processor and at least one memory communicatively coupled to the at least one processor, and operable to perform, execute or control performance of the method 600.

The method 600 starts at 602. For example, the method 600 may start in response to a turning ON or booting up of the incentive allocation server computer 131, or in response to receiving information, for instance information from the tracking server computer 124 and/or the Web content server computer 120 (FIG. 1).

At 604, the incentive allocation server computer 131 determines an incentive or an offer for a first user. The incentive allocation server computer 131 may determine a type of offer and/or a size, amount or even a frequency of the offer. Offers may be for goods and/or services and/or access to controlled content or information, for example, access through a pay wall Website, or free or discounted access to content, products, or services. For example, the incentive allocation server computer 131 may determine that for driving a defined amount of traffic to a particular Website over a defined period, the user who drove the traffic receives an offer for free access to a Website that normally requires a paid subscription. The length or duration of access may be set based on the level of traffic driven and/or the quality of the traffic driven (e.g., number or percentage of conversions). A level of access may be set based on the level of traffic driven and/or the quality of the traffic driven. In some embodiments, instead of an offer, an incentive may be a prompt to the user with a request to share content, or the user may be given a message, such as a thank you message for a user's loyalty as a social user.

In some embodiments, the incentive or offer may be based on tracking Web page visits of a plurality of users to a Web page which were a result of a particular request to a data sharing server computer originating from a client device associated with the first user. In some embodiments, the request regards dissemination of information associated with the Web page. In some embodiments, the offer may incentivize a first user and/or behavior to drive traffic to various Websites. In some embodiments, high-value actions may be algorithmically driven. In some embodiments, amplification is achieved such that the power of a sharing user can be tracked. In some embodiments, the value of social networking may be quantified. In some embodiments, return on investment may be shown.

At 606, the incentive allocation server computer 131 may send or otherwise provide the offer to the first user. In some embodiments, the first user may receive a user prompt. Those skilled in the art will appreciate that the offer may be sent or provided in a variety of ways. Such may include redeemable offers which may be selected (e.g., clicked on), redeemable codes or passwords which may be entered, redeemable vouchers which may be printed and scanned, or access through a pay wall to a paid Website or other offering.

The method 600 may terminate or end at 608. Alternatively, the method 600 may repeat, either continuously, periodically or aperiodically, for example in response to receipt of additional information from the tracking serer computer(s) and/or Web content server computer(s).

In some embodiments, the incentive allocation server computer 131 provides user interfaces for engaging a user, as discussed above. FIG. 16 shows an exemplary user interface 400 that may be presented by the incentive allocation server computer 131, according to one illustrated embodiment. As previously explained, the incentive allocation server computer 131 may be implemented by the tracking server 124, the data attribution system 129, and/or the Web content server computer 120, each illustrated and described previously.

The user interface 400 includes a table of users 402. An action type pull down menu or pallet 404 allows an action type to be selected for evaluating one or more users. In some embodiments, an action type may comprise the type of user action that is too be incentivized or evaluated. Actions might, for example, include “likes” to FACEBOOK® or “pins” to PINTEREST®.

A number of checkbox fields allow selection of the particular social network or social media providers or platforms for which the users in the table of users 402 may be incentivized for or otherwise evaluated against. Social network or social media providers or platforms may, for example, include FACEBOOK®, TWITTER®, LINKEDIN®, PINTEREST®, MYSPACE®, GOOGLE+®, TAGGED®, DIGG®, YOUTUBE®, LIVE JOURNAL®, ORKUT®, to name a few.

The user interface 400 may include a set of metrics fields 408 that allows definition of the baseline metrics for which the users in the table of users 402 may be incentivized for or otherwise evaluated against.

The metrics may for example include numbers of specific actions generated by the recommendation, referral or sharing actions of the user or client device. For instance, metrics may include a baseline number or amount of selections or clicks generated by the recommendation, referral or sharing actions of the user or client device. The metrics may include a baseline number for views generated by the recommendation, referral or sharing actions of the user or client device. The metrics may include baseline amount for revenue generated by the recommendation, referral or sharing actions of the user or client device. The metrics may include baseline number for the number of subscriptions generated by the recommendation, referral or sharing actions of the user or client device.

A set of fields 410 allows the combination of actions, metrics and filters to be named and saved as a cohort.

The table of users 402 may comprise columns or fields that provide specific information for each of the users in the table of users 402.

These columns or fields may, for example include rank column or field 420 which indicate a relative rank or position of users with respect to one another.

A user ID column or field 422 provides a user identifier. The user identifier may be a value that allows the actual name of the user to remain anonymous.

A page views column or field 424 indicates the number of page views generated by the recommendation, referral or sharing actions of the user or client device.

A total shares column or field 426 indicates the total number of sharing actions of the user or client device, irrespective of social network or social media provider or platform.

An amplification column or field 428 provides a value indicative of how much a user's recommendation, referral or sharing actions are amplified. Such may reflect the effectiveness of the user at driving traffic.

A total share clicks column or field 430 indicates the total number of clicks generated by any recommendation, referral or sharing actions of the user or client device, irrespective of social network or social media provider or platform. A FACEBOOK® share clicks column or field 432 indicates the total number of clicks generated by recommendation, referral or sharing actions related to FACEBOOK® by the user or client device. TWITTER® share clicks column or field 434 indicates the total number of clicks generated by recommendation, referral or sharing actions related to TWITTER® by the user or client device. PINTEREST® share clicks column or field 436 indicates the total number of clicks generated by recommendation, referral or sharing actions related to PINTEREST® by the user or client device. An e-mail share clicks column or field 438 indicates the total number of clicks generated by recommendation, referral or sharing actions via email sharing by the user or client device.

A referral subscriptions column or field 440 provides an indication of the number of subscriptions generated by recommendation, referral or sharing actions by the user or client device.

A social revenue generated column or field 442 provides an indication of a value of revenue generated by recommendation, referral or sharing actions by the user or client device. The social revenue may take into account variations in what a sharing action is worth at any given time. Such may be an estimate or projection of revenue that a sharing action is likely to generate.

A direct revenue generated column or field 444 provides an indication of an amount of revenue directly generated by recommendation, referral or sharing actions by the user or client device.

A total generated column or field 446 provides an indication of a total amount of revenue generated by recommendation, referral or sharing actions by the user or client device. Such may be a sum of the social revenue generated and the direct revenue generated.

A last seen date column or field 448 provides an indication of the last date on which a particular user or client device was identified as making recommendation, referral or sharing action.

The analysis of the columns or fields may be performed as a detailed analysis of an individual user or a detailed analysis of a group of users.

FIG. 17 shows an exemplary user interface 1700 that may be presented by the incentive allocation server computer 131, according to one illustrative embodiment. As previously explained, the incentive allocation server computer 131 may be implemented by the tracking server 124, the data attribution system 129, and/or the Web content server computer 120, each illustrated and described previously.

The user interface 1700 includes a table of summarized information 1760 of users or cohorts. The table 1760 may comprise rows or fields of groups of users, and may comprise columns or fields that provide specific information for each of the rows in the table 1760. The columns or fields may be grouped by revenue 1720, amplification 1730, and sharing 1740.

An all-users row or field 1702 provides information for all the users of the table 1760.

A top 20% revenue drivers row or field 1704 provides information of the users that are driving the top 20% of the revenue, relative to all of the users of the table 1760.

A top 20% shares row or field 1706 provides information of the users who have a number of sharing actions that are within the top 20% of the number of sharing actions, relative to all of the users of the table 1760.

A top 20% inside social score row or field 1708 provides information of the users who scored within the top 20% of referral or sharing actions that are amplified, relative to all of the users of the table 1760.

A total revenue column or field 1722, of the revenue group 1720, provides an indication of an amount of revenue directly generated by recommendation, referral or sharing actions by the user groupings of the rows of the table 1760.

A revenue per user column or field 1724, of the revenue group 1720, provides an indication of an amount of revenue directly generated by recommendation, referral or sharing actions by the user groupings of the rows of the table 1760.

A percentage of total revenue (% of total revenue) column or field 1726, of the revenue group 1720, provides an indication of the percent of total revenue of the user groupings of the rows of the table 1760, relative to the all-users row 1702.

An Inside Social score column or field 1732, of the amplification group 1730, provides a value indicative of the recommendations, referrals or sharing actions that are amplified by the user groupings of the rows of the table 1760. Such may reflect the effectiveness of the users at driving traffic.

A page views column or field 1734, of the amplification group 1730, provides an indication of the count of the page views that were amplified by the user groupings of the rows of the table 1760.

A new visits column or field 1736, of the amplification group 1730, provides an indication of the count of visits to a page that are new visits that were amplified by the user groupings of the rows of the table 1760.

A shares column or field 1742, of the sharing group 1740, provides an indication of the count of the recommendations, referrals or sharing actions that caused or drove amplification by the user groupings of the rows of the table 1760.

A share percentage (share %) column or field 1744, of the sharing group 1740, provides an indication of the percent of shares of the user groupings of the rows of the table 1760, relative to the all-users row 1702.

The table 1760 may be modified by a date control 1750 to restrict, limit or filter the information displayed in the table 1760 by a date range. Furthermore, the user may hover over or click on a column heading, a row heading or a field of the table 1760 in order to drill down to additional information.

FIG. 18 shows an exemplary user interface 1800 that may be presented by the incentive allocation server computer 131, according to one illustrative embodiment.

The user interface 1800 is similar to the user interface 1700 described above, however the user interface 1800 includes an advanced details section 1810 that illustrates additional summarized data indicative of the top 20% shares 1706 row of the table 1760. Of course, advanced details section 1810 is applicable to any row of table 1760.

A social network or social media providers or platforms subsection 1820 may provide user groupings based on individual social network or social media providers or platforms, and/or groupings of social network or social media providers or platforms. Subsection 1820 illustrates FACEBOOK®, TWITTER®, e-mail and others.

A graphing subsection 1830 provides graphs of the column groupings revenue 1720, amplification 1730, and sharing 1740.

A revenue pie chart section 1832 shows a pie chart of the percentage revenue of the social network or social media providers or platforms of subsection 1820.

An amplification area graph section 1834 shows an area graph of the amplification achieved by the users having a top 20% Inside Social score. The area graph of 1834 shows an amplification of 3.5×.

A shares bar chart section shows a bar chart of the sharing grouped by social network or social media providers or platforms.

FIG. 19 shows an exemplary user interface 1900 that may be presented by the incentive allocation server computer 131, according to one illustrative embodiment. As previously explained, the incentive allocation server computer 131 may be implemented by the tracking server 124, the data attribution system 129, and/or the Web content server computer 120, each illustrated and described previously.

The user interface 1900 includes graphs and controls to modify the display of the graphs.

A network control 1902 can be used to select to display the data of particular social network or social media providers or platforms. For example, the network control 1902 may provide the selection of one or more of FACEBOOK®, TWITTER®, PINTEREST®, e-mail, or all of the above.

A date control 1904 can be used to restrict, limit or filter the information displayed in the graphs of display 1900 by a date range.

A social revenue line chart 1906 shows for each day in a time period the total social revenue generated for the day. For example, on February 5, $71,264 was generated based on three networks selected by network control 1902. Such may be an estimate or projection of revenue that a sharing action is likely to generate.

An Inside Social score line graph 1908 shows for each month in a time period the Inside Social score. For example, the Inside Social score in May was 51.

A shares pie chart 1910 shows the percentage of total shares for each social network or social media provider selected by network control 1902. For example, the percentage of shares for FACEBOOK® is 47%.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary tracking of user referral actions generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, and computer memory; and other non-transitory computer-readable storage media.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/799,245, filed Mar. 15, 2013, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a Web server including at least one processor and at least one memory communicatively coupled to the at least one processor, the method comprising:
receiving, by the at least one processor of the Web server, a Web page request for a Web page from a client;
generating, by the at least one processor of the Web server, a Web page request identifier based on the received Web page request to uniquely identify the Web page request from other requests received by the Web server for the Web page and from requests for other Web pages;
including, by the at least one processor of the Web server, the Web page request identifier in a metadata tag of the requested Web page;
including, by the at least one processor of the Web server, a client side executable script with the Web page, the client side executable script which, when executed by a client side processor, causes the client to transmit a digital package including at least the Web page request identifier and a user identifier logically associable with the client; and
transmitting, by the at least one processor of the Web server, the Web page including the Web page request identifier and including the client side executable script to the client in response to the request from the client.

2. The method of claim 1 wherein the inclusion of the Web page request identifier in the metadata tag of the requested Web page causes, subsequent to the transmission of the digital package, a data sharing server to communicate the Web page request identifier to a tracking server remote from the data sharing server should the client transmit a request to the data sharing server regarding dissemination of information associated with the requested Web page to one or more users.

3. The method of claim 1 wherein the client side executable script, when executed, further causes the client to modify data indicative of a Web address of the Web page to include in the Web address of the Web page a user identifier associated with the client.

4. The method of claim 1 wherein the Web address of the Web page is a URL.

5. The method of claim 1 wherein the Web page request identifier includes a reference to a tracking server.

6. A non-transitory computer-readable storage medium having computer executable instructions stored thereon that, when executed by at least one processor, cause the at least one processor to:
read or generate a particular user identifier associated with a user who requested a Web page;
read a Web page request identifier in a metadata tag of the requested Web page, the Web page request identifier having one or more attributes which uniquely identify a request for the Web page from other requests received by a Web server for the Web page and from requests for other Web pages;
determine whether data indicative of a Web address of the requested Web page includes an indication of a user identifier;
if it is determined that the data indicative of the Web address of the requested Web page includes the indication of a user identifier, then transmit to a tracking server a digital package including at least the Web page request identifier, the indication of the user identifier that is included in the data indicative of the Web address of the requested Web page, and the particular user identifier associated with the user who requested the Web page.

7. The non-transitory computer-readable storage medium of claim 6 wherein if it is determined that the data indicative of the Web address of the requested Web page does not include the indication of a user identifier then modify the data indicative of the Web address of the requested Web page to include in the Web address of the requested Web page an indication of the particular user identifier associated with the user who requested the Web page.

8. The non-transitory computer-readable storage medium of claim 7 wherein the indication of the particular user identifier is a hash of the particular user identifier.

9. The non-transitory computer-readable storage medium of claim 7 wherein the indication of the particular user identifier is a query string of the particular user identifier.

10. The non-transitory computer-readable storage medium of claim 7 wherein the particular user identifier associated with the user who requested the Web page is an identifier of a client that generated the Web page request.

11. The non-transitory computer-readable storage medium of claim 7 wherein the particular user identifier is compared with the indication of the user identifier.

12. A method in a tracking server including at least one processor and at least one memory communicatively coupled to the at least one processor, the method comprising:
receiving from a client, by the at least one processor of the tracking server, a digital package including at least a Web page request identifier of a Web page request for a Web page made to a Web server from the client and a user identifier logically associable with the client, the Web page request identifier uniquely identifying the Web page request from other requests received by the Web server for the Web page and from requests for other Web pages;
storing, by the at least one processor of the tracking server, the Web page request identifier and the user identifier;
receiving, by the at least one processor of the tracking server, a request via a data sharing server for data associated with an identifier included in the received data request;
in response to receiving the request via the data sharing server, comparing, by the at least one processor of the tracking server, the stored Web page request identifier to the identifier included in the data request received via the data sharing server; and
logically associating in a database stored on the at least one memory, by the at least one processor of the tracking server, a request from the client to the data sharing server regarding dissemination of information associated with the requested Web page with the data request received via the data sharing server, based at least in part on an outcome of the comparison.

13. The method of claim 12, further comprising:
in response to the data request received via the data sharing server, transmitting, by the at least one processor of the tracking server, the requested data to the data sharing server.

14. The method of claim 12 wherein the Web page request identifier is indicative of an image stored by the tracking server.

15. The method of claim 12, further comprising:
associating in the database, by the at least one processor of the tracking server, the user identifier with the Web page request.

16. A method in a data sharing attribution system including at least one processor and at least one memory communicatively coupled to the at least one processor, the method comprising:
receiving, by the at least one processor of the data sharing attribution system, data indicative of a first client associated with a first user;
associating, by the at least one processor of the data sharing attribution system, a request to a data sharing server originating from the first client regarding dissemination of information associated with a Web page with subsequent Web page requests of a plurality of additional clients associated with a plurality of additional users based on modified Web page addresses associated with the Web page and tracking the request to the data sharing server via content requests resulting from the request to the data sharing server, the modified Web addresses including data indicative of which of the plurality of additional clients the subsequent requests were from;
attributing, by the at least one processor of the data sharing attribution system, the subsequent Web page requests to the first user based on the received data indicative of the first client associated with the first user, and based on the association of the subsequent Web page requests with the request to the data sharing server originating from the first client; and
determining a value of the communication originating from the first client based on the attribution.

17. A method in a server including at least one processor and at least one memory communicatively coupled to the at least one processor, the method comprising:
determining, by the at least one processor of the server, an incentive for a first user based on tracking Web page visits of a plurality of users to a Web page which were a result of a particular request to a data sharing server originating from a client associated with the first user, the request regarding dissemination of information associated with the Web page; and
sending, by the at least one processor of the server, the incentive to the first user.

18. The method of claim 17 wherein the incentive is an offer.

19. The method of claim 17 wherein the incentive is a prompt.

20. The method of claim 17 wherein the incentive is access to content through a pay wall Website.
